(19) United States
(12) Patent Application Publication
(10) Pub. No.: US 2016/0278561 A1
(43) Pub. Date: Sep. 29, 2016

(54) JUICE EXTRACTION DEVICES WITH MESH FILTER OF VARIABLE DISTANCES FROM HELICAL SCREW

(71) Applicant: GOLDEN CHOICE PRODUCTS LTD., Hong Kong (CN)

(72) Inventors: Kwan Kit Chan, Hong Kong (CN); Chung Ming Chan, Hong Kong (CN)

(73) Assignee: Golden Choice Products Ltd., Hong Kong (CN)

(21) Appl. No.: 15/035,362

(22) PCT Filed: Oct. 29, 2014
(86) PCT No.: PCT/CN2014/089814

§ 371 Date: May 9, 2016

(30) Foreign Application Priority Data
Nov. 12, 2013 (HK) 13112660.9

(51) Int. Cl. A47J 19/02

(52) U.S. Cl. CPC A47J 19/025; A47J 19/02

(57) ABSTRACT

Juice extraction device (100) is provided for extracting juice from food including a housing (102) having at least one food inlet (104); a process chamber unit (210) having at least one opening matching the at least one food inlet (104) to receive the food; a helical screw (220) capable of being rotated by a driver connected thereto along an axis; a mesh filter unit (230) for separating he juice from the food, said mesh filter unit (230) connected to the process chamber unit (210) to encompass the helical screw (220), wherein the mesh filter unit (230) has a cross-sectional shape perpendicular to the axis; at least one outlet (242) where the juice exits, the at least one outlet (242) is at a side of the mesh filter unit (230), wherein the distance between the helical screw (220) and the mesh filter unit (230) varies. The present juice extraction device (100) is versatile and is applicable to a wide range of food including vegetables with various textures and hardness compared to the same type of juice extraction devices of the prior art, while maintaining cost to be relatively low.

### FIELD OF THE INVENTION

This invention relates to juice extraction device for extracting juice from food, particularly those operate at about 40-300 rounds per minute, or so called “slow juicers”.

### BACKGROUND OF THE INVENTION

Juice extraction device is a kind of home appliance for extracting juice from food, such as fruit, herbs, leafy greens, vegetable and the like. Currently there are three types of commercial juice extraction devices (or juicers) available: (1) centrifugal juicers using blades and a sieve to separate juice from pulp; (2) masticating juicers “chewing” food to pulp before squeezing the juice out from the pulp; and (3) triturating juicers having twin gears for first crushing food, and then pressing food.

Centrifugal juicers with low price and quick juice extraction are the most widely used.

However, the yield efficiency of centrifugal juicer is generally lower than that of the other two types of juicers. Further, flavor and nutrition in food may degrade due to oxidation caused by the high speed crushing process. In addition, centrifugal juicer is not that capable to break fibers in vegetables like wheatgrass. Such centrifugal juicers are described, for example, in U.S. Pat. No. 5,479,851, U.S. Pat. No. 6,050,180 and U.S. Pat. No. 7,040,220.

Masticating juicers with affordable price use a profiled screw style molding to compact and crush fruit and vegetable matters against meshes, allowing juice to flow through the meshes while expelling the fruit and vegetable matters. This low speed juicing process minimizes oxidation, which is believed to damage or destroy enzymes contained in juice, and thus could preserve nutrition and flavor of juice. Masticating juicer is also applicable to food other than fruits, such as vegetables. Therefore, masticating juicers are getting popular recently. Such masticating juicers are described, for example, in US2003/0154867A1 and US2009/0049998A1.

To achieve better extraction efficiency, triturating juicer is provided, which employs two metal counter-rotating gears to crush food. The precise tolerance of the gears allows juice to flow through the gap between the gears, while pulp matters pass along the top of the gears and are discharged. However, triturating juicer is much more expensive than the other two types of juicers, as high level of precision engineering is required. One such triturating juice is described in U.S. Pat. No. 5,592,873.

Fruits and vegetables have a range of textures and hardness that the juice extraction may require different criteria to maximize efficiency of the juice extraction process. There are multi speeds centrifugal juicers available in the market to match such demands. Centrifugal juicers run on high speed in the range of thousands to tens of thousands RPM, which can be adjusted electronically to give the preferred speed for the extraction process, namely, lower speed for soft food matters such as grapes, and higher speed for hard food matters such as apples and carrots. Typically the range of speed is from 6000 RPM to 13000 RPM in step increment of around 1500 RPM.

For masticating or triturating juicers, the speed is relatively slow in the region of lower hundreds RPM and there is little flexibility in this respect. Also the mechanics of the juicing process is based on the pressing pressure rather than the speed, therefore slow juicers simply run on a given speed and a given pressing pressure governed by the geometric structure of the juicers.

Therefore, it is desirable to provide a juice extraction device having improved juice extraction efficiency with relatively low cost.

### OBJECTS OF THE INVENTION

An object of this invention is to provide a juice extraction device with improved juice extraction efficiency and/or applicable to fruits and vegetables over a range of textures and hardness compared to the same type of the juice extraction devices of the prior art, while maintaining the cost to be relatively low.

### SUMMARY OF THE INVENTION

Accordingly, this invention provides a juice extraction device for extracting juice from food, including:
a housing having at least one food inlet;
a process chamber unit having at least one opening matching the at least one food inlet to receive the food;
a helical screw capable of being rotated by a driver connected thereto along an axis;
a mesh filter unit for separating the juice from the food, said mesh filter unit connected to the process chamber unit to encompass the helical screw, wherein the mesh filter unit has a cross-sectional shape perpendicular to the axis;
at least one outlet where the juice exits, the at least one outlet is at a side of the mesh filter unit,
characterized in that the distance between the helical screw and the mesh filter unit varies.

Preferably, the mesh filter unit includes at least a contour mesh filter. More preferably, the cross-sectional shape of the contour mesh filter is circular, or is semi-ellipsoidal or ellipsoidal. Alternatively, the cross-sectional shape of the contour mesh filter is irregular polygon.

Preferably, the juice extraction device further includes a cutter drum unit having at least one cutting element for cutting the food from the at least one food inlet, the cutter drum unit is capable of being rotated by the driver connected thereto along the axis and encompasses at least part of the process chamber unit. More preferably, the cutter drum unit has a plurality of cutting elements, and the plurality of cutting elements has at least two different sizes and at least two different shapes. Even more preferably, the shapes of the plurality of cutting elements includes at least strip and slice shapes, a reciprocating blade, when the cutting element is driven to rotate, the reciprocating blade is moved in a reciprocating manner, and/or a plurality of vertical blades, the edges of the vertical blades are perpendicular to those of the reciprocating blade.

Preferably, the driver is a manual driver or a motor.

Preferably, the juice extraction device further includes a cap with at least one waste outlet on a tip side thereof, the cap matches a tip end of the helical screw and is connected to the housing.

### BRIEF DESCRIPTION OF THE DRAWINGS

Preferred embodiments of the present invention will now be explained by way of example and with reference to the accompanying drawings in which:

FIG. 1 shows an exploded view of an exemplary juice extraction device of the present invention;

FIG. 2 shows another exploded view of the juice extraction device of FIG. 1;

FIG. 3 shows s cutaway view of the assembled juice extraction device of FIG. 2;

FIG. 4 shows a longitudinal section view of the juice extraction device of FIG. 3;

FIG. 5 shows a cross section view of the juice extraction device of FIG. 3;

FIG. 6 shows an exploded view of the juice extraction mechanism and the cap of the juice extraction device of FIG. 1;

FIG. 7 shows a sectional view of an exemplary cap of the juice extraction device of FIG. 1;

FIG. 8 shows a cutaway view of assembled cap, mesh filter unit, helical screw and dehydrated waste collector, and juice collector;

FIG. 9 shows a front isometric view of a helical screw fitted inside a first exemplary mesh filter unit and process chamber unit;

FIG. 10 shows a cross-sectional view of the helical screw fitted inside the assembled mesh filter unit of FIG. 9;

FIG. 11 shows a cross-sectional view of the helical screw fitted inside a second exemplary mesh filter unit of the present invention;

FIG. 12 shows a cross-sectional view of the helical screw fitted inside a third exemplary mesh filter unit of the present invention;

FIG. 13 shows a cutaway view of the assembled juice extraction device of FIG. 3, omitting its mesh filter unit, juice collector and cap;

FIG. 14 shows a partial dissembled view of the juice extraction device in FIG. 13;

FIG. 15 shows a first exemplary cutter drum unit of this invention;

FIG. 16 shows a second exemplary cutter drum unit of this invention; and

FIG. 17 shows a third exemplary cutter drum unit of this invention.

### DETAILED DESCRIPTION OF THE PREFERRED EMBODIMENT

This invention is now described by way of examples with reference to the figures in the following paragraphs. Objects, features, and aspects of the present invention are disclosed in or are apparent from the following description. It is to be understood by one of ordinary skilled in the art that the present discussion is a description of exemplary embodiments only, and is not intended as limiting the broader aspects of the present invention, which broader aspects are embodied in the exemplary constructions. List 1 is a list showing the parts and respective reference numerals in the figures.

List 1

| Reference numeral | Part name |
|---|---|
| 100 | Juice extraction device |
| 102 | Housing |
| 104 | Feed chute |
| 106 | Push rod |
| 108 | Supporting base |
| 200 | Juice extraction mechanism |
| 210 | Process chamber unit |
| 212 | Protrusion |
| 220 | Helical screw |
| 222 | Spiral screw blades |
| 226 | Helical screw conical front end |
| 230 | Mesh filter unit |
| 232 | Contour mesh filter |
| 234 | Waste outlet on mesh filter unit |
| 236 | Inner spiral layer at mesh filter unit |
| 238 | Adjustment screw |
| 240 | Cap |
| 242 | Juice outlet |
| 244 | Waste outlet on cap |
| 300 | Cutter drum unit |
| 302 | Cutting element |
| 304 | Strip cutting element |
| 306 | Slice cutting element |
| 308 | Reciprocating blade |
| 310 | Moving block |
| 312 | Ring with zig-zag contour profile |
| 314 | Zig-Zag profile rail |
| 316 | Vertical blade |
| 400 | Receiving unit |
| 402 | Dehydrated waste collector |
| 404 | Juice collector |
| 500 | Drive mechanism |

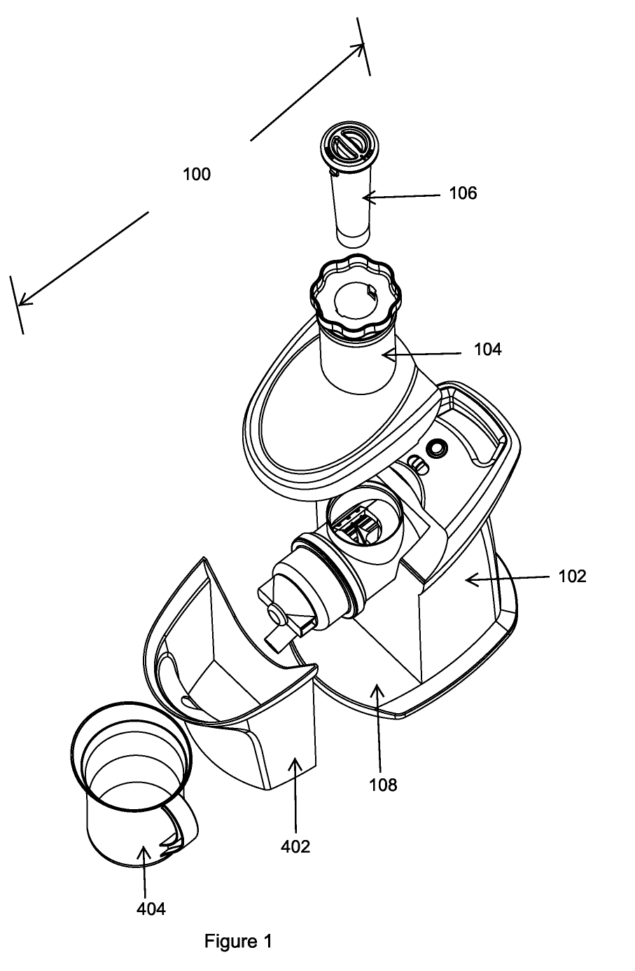

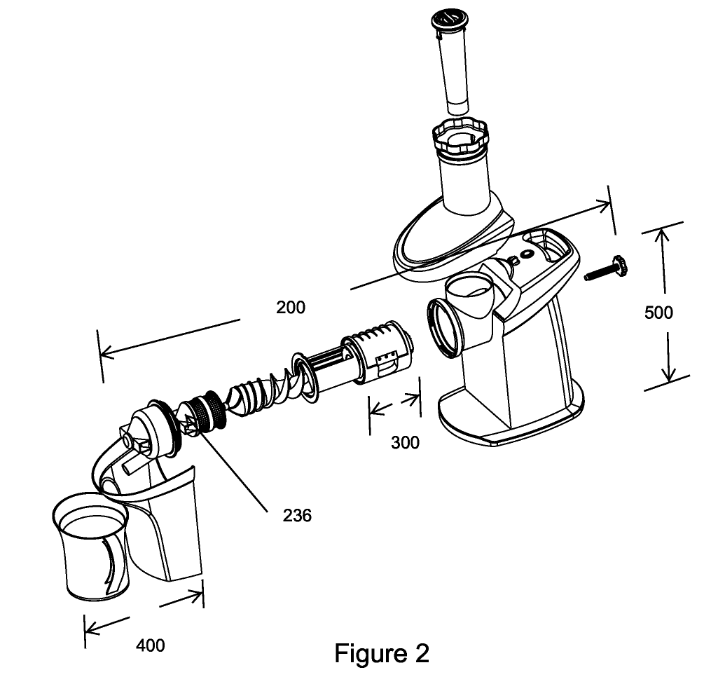

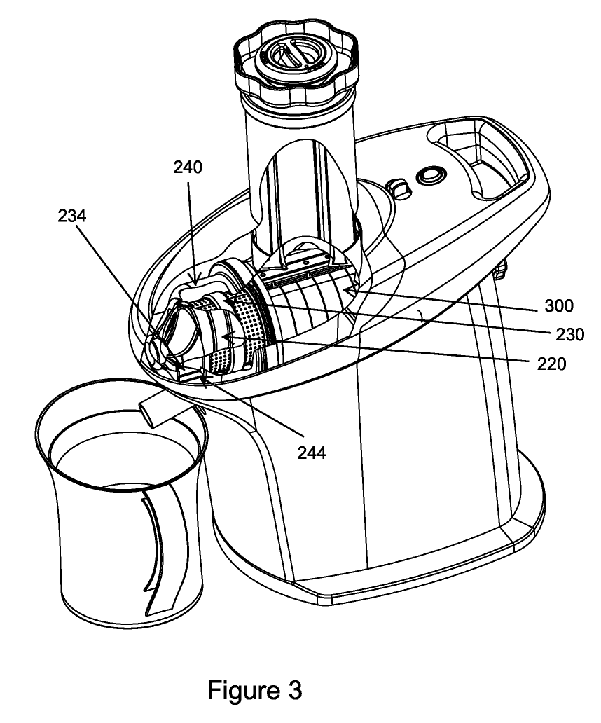

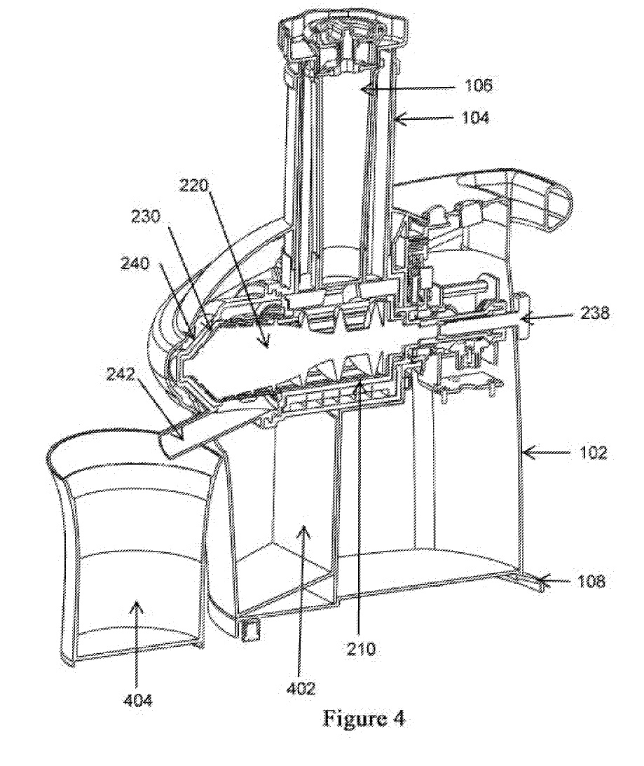

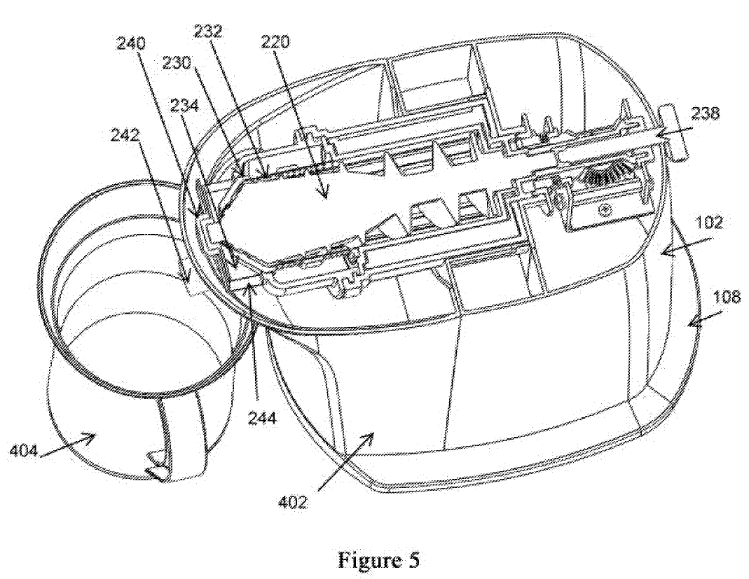

An exemplary juice extraction device 100 of this invention is shown in FIG. 1 to FIG. 5. The juice extraction device 100 has juice extraction mechanism 200 for extracting juice from food and a housing 102. In this particular embodiment, the juice extraction mechanism 200 is enclosed by a cap 240 connected to the housing 102, together forming a space accommodating the juice extraction mechanism 200. This cap 240 is shown to be a separated component for ease of cleaning, but can be unified with the housing 102 if desired. A feed chute 104 is provided on the top side of the housing 102 as a food inlet, and an optional push rod 106 is provided for easily pushing food. The number and specific form of the food inlet is not important in this invention, as long as the food can be input through it. A juice outlet 242, where the juice exits, is provided on the bottom side of the cap 240. A pair of waste outlets on cap 244, through which the waste exits, is provided on the tip of the cap 240. A drive mechanism 500 for driving the extraction mechanism 200 is connected to the juice extraction mechanism 200 such that the extraction mechanism 200 can be driven by the drive mechanism 500. The drive mechanism 500 is driven manually or by a motor, and it drives the juice extraction mechanism 200 to rotate through for example, engaging gears. For collection and cleaning convenience, optional dehydrated waste collector 402 and juice collector 404 can be provided to collect dehydrated waste exits from the pair of waste outlets on cap 244 and juice exits from the juice outlet 242, respectively. For ease of placement, an optional supporting base 108 is provided to support the housing 102 to be put on a flat surface, like table top.

In this particular embodiment shown in FIG. 1 to FIG. 5, the cap 240, housing 102, the dehydrated waste collector 402 and the juice collector 404 are provided separately.

However, any of them could be unified with the housing 102 if desired, for example, the housing 102 may be designed to have the cap 240 unified, and thus a separated cap 240 is not required. Further, the driver of the present invention could be any conventional driver used in the existing juicers, such as a manual driver driven by a user, or an electric motor. In addition, the drive mechanism 500 can also be any conventional driving mechanism in the existing juicers, for example, a driving mechanism using gear system or shaft system. That is, the drive mechanism 500 can drive the juice extraction mechanism 200 through coupling gears or a rotating shaft.

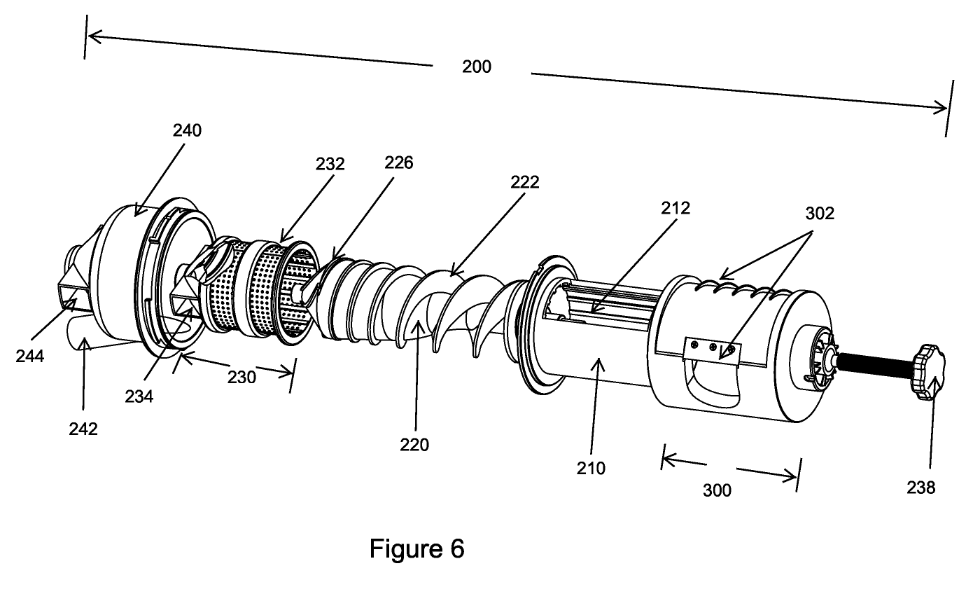

Exploded view of the juice extraction mechanism 200 and the cap 240 is shown in FIG. 6. In this particular embodiment, the juice extraction mechanism 200 includes a process chamber unit 210 for accepting food input from the feed chute 104, mesh filter unit 230 connected to the process chamber unit 210 for separating juice from the food, and a helical screw 220 for pushing and pressing the pulp matters of the food, which are a mixture of the food's juice and fiber. The process chamber unit 210 has a receiving opening matching the inlet on the housing 102 to receive food from the feed chute 104 on the housing 102. The mesh filter unit 230 at least has a contour mesh filter 232. One end of the contour mesh filter 232 is connected to the process chamber unit 210, and thus forming work space for the helical screw 220. Preferably, the mesh filter unit 230 includes an inner spiral layer 236 connected to the conical end of the contour mesh filter 232. The inner spiral layer 236 has a shape corresponding to the helical screw conical front end 226 to further press the pulp matters having reached at the helical screw conical front end 226 to improve juicy extraction efficiency, and is provided with a pair of waste outlet 234 through which the dehydrated waste exits to the dehydrated waste collector 402. The gap between the inner spiral layer 236 and the helical screw conical front end 226 is adjusted by a adjustment screw 238 connected to the helical screw 220. The helical screw 220 of the present invention can be rotated by the drive mechanism 500 connected thereto, which may be any suitable screw, for example, the screw in US2003/0154867A1 and US2009/0049998A1. In addition, the processing chamber unit 210 and the mesh filter unit 230 are two separated parts in this particular embodiment. However, they can be designed as unified if desired.

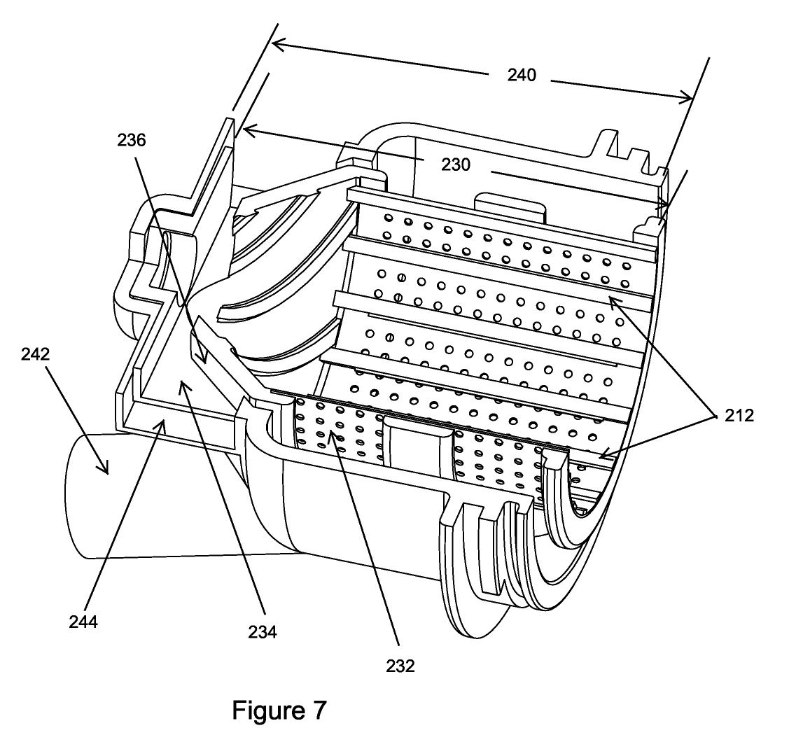

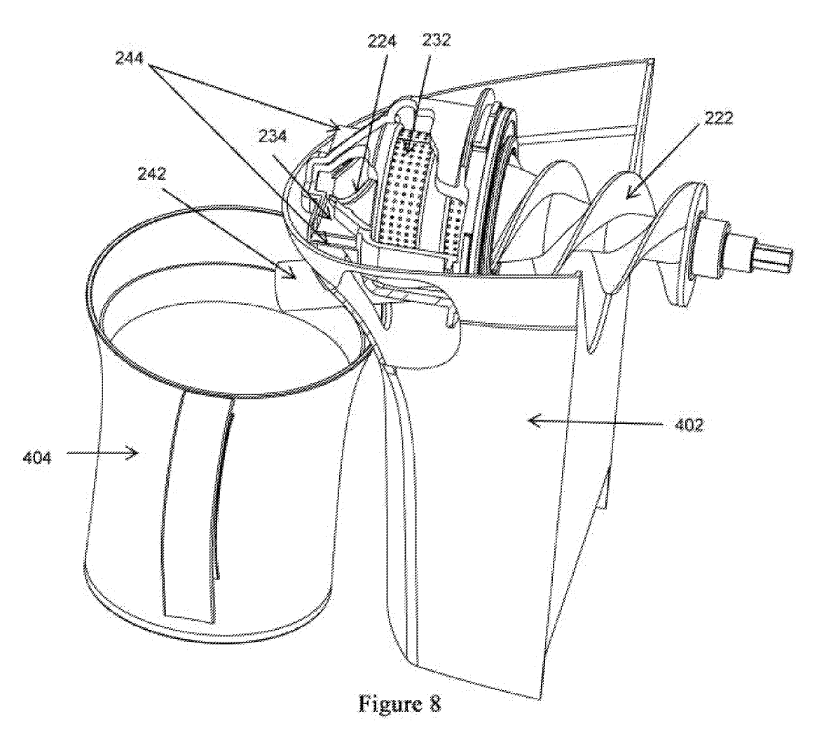

A sectional view of the mesh filter unit 230 fitted in the cap 240 is shown in FIG. 7, and a cutaway view of assembled cap, mesh filter unit, helical screw and dehydrated waste collector, and juice collector is shown in FIG. 8. As shown in FIGS. 7 and 8, the cap 240 of the present invention is essentially a locking device to hold the mesh filter unit in position, and also provide a juice outlet tube as well as a matching pair of waste outlets 244 for the waste to exit to the collector. Preferably, the cap 240 has a shape matching the mesh filter unit 230. Specifically, the cap 240 has a pair of waste outlets 244 corresponding to the pair of waste outlets 234 on the mesh filter unit 230, which in this embodiment surrounds the entire mesh filter unit 230, and is connected to the process chamber unit 210. Juice filtered from the mesh filter unit 230 is collected by the juice collector 404 via the juice outlet 242 on the bottom side of the cap 240.

With a volume displacement differential as the helical screw turns, the pulp matters, the juice and fibers are crushed and broken down by the screw blade in the space formed by the process chamber unit 210 and the mesh filter unit 230. The pulp matters are being pushed forward as the helical screw 220 turns due to the volume displacement differential, and the pulp matters are gradually crushed and squeeze down the course of the spiral rotation. The pulp matters that have reached the helical screw conical front end 226 are further pressed by the helical screw conical front end 226 against the matching inner spiral layer 236. Again due to the displacement volume differential, the dehydrated pulp matters are then squeezed out of the waste outlets 234 on the mesh filter unit 230 and the waste outlets 244 on the cap 240 to the dehydrated waste collector 402. In this particular embodiment, the pair of waste outlets 234 on the mesh filter unit 230 is a pair of openings corresponding to the pair of the waste outlets 244 on the cap 240. However, the shape and number of the wastes outlets 244 on the cap 240 are not limited, and it could be any desired shape and any number on or near the tip of the cap 240, as long as the waste can exit after being further pressed by the helical screw conical front end 226. The waste outlets 234 on the mesh filter unit 230 are connected to the tip end of the inner spiral layer 236, and the tip end of the inner spiral layer 236 matches and secures the tip end of the helical screw 220 such that the dehydrated pulp matters, or the waste after the juicing process, can be further pressed and then pushed out by the rotating helical screw conical front end 226. Spirals of the inner spiral layer 236 mesh with the spirals of the helical screw conical front end 226, such that an exit pathway for the dehydrated waste is formed.

When food is input from the feed chute 104, and the drive mechanism 500 begins to drive the helical screw 220 to rotate, the food is pushed, cut and pressed by the rotating blades 222 of the helical screw 220 against the process chamber unit 210 and the contour mesh filter 232. Juice is thus separated from the pulp matters by the mesh filter unit 230 and exits through the juice outlet 242, while pulp matters with their juice extracted are pushed forward to the tip end of the helical screw 220. At the helical screw conical front end 226, the pulp matters are further pressed by the helical screw conical front end 226 against the inner spiral layer 236. The separated juice is drained through the juice outlet 242, while the dehydrated waste is pushed out through the waste outlets 234 on the mesh filter unit 230 by the rotational spiral tip of the helical screw 220. To facilitate the collection of the separated juice, the juice outlet 242 is located at the bottom side of the cap 240, and the pair of waste outlets 234 on the mesh filter unit 230 are located at the front end of the inner spiral layer 236.

To achieve good juice extraction efficiency applicable to a variety of food matters with a range of textures, it is desirable to operate the juice extraction device over a range of pressing pressures whereby the juice from food matters can be extracted in a favorable condition appropriate to the given pulp matters. The pressing pressure derives from the volumetric differential displacement within the cavity section of the helical screw 220 pushing the pulp matters against the contour mesh filter 232 and therefore the pressing pressure at a given cavity section varies as the depth of the pulp matters between the contour mesh filter 232 and the helical screw 220 at that given cavity section. In other words, the changes in pressing pressure is inversely proportional to the depth of the pulp matters so contained. That is, the shallower the depth of the pulp matters, the higher will be the pressing pressure. It is apparent that the juice extraction pressing pressure (therefore its associated extraction efficiency) is significantly higher towards the conical end as oppose to the feeding end of the helical screw due to the fact that the volume of the last cavity section is only a small fraction of the initial cavity volume at the feeding end. This volumetric contraction translates into a reduction in pulp depth whereby results in a surge in pressing pressure as the helical blade turns and pushes the pulp matters within the cavity.

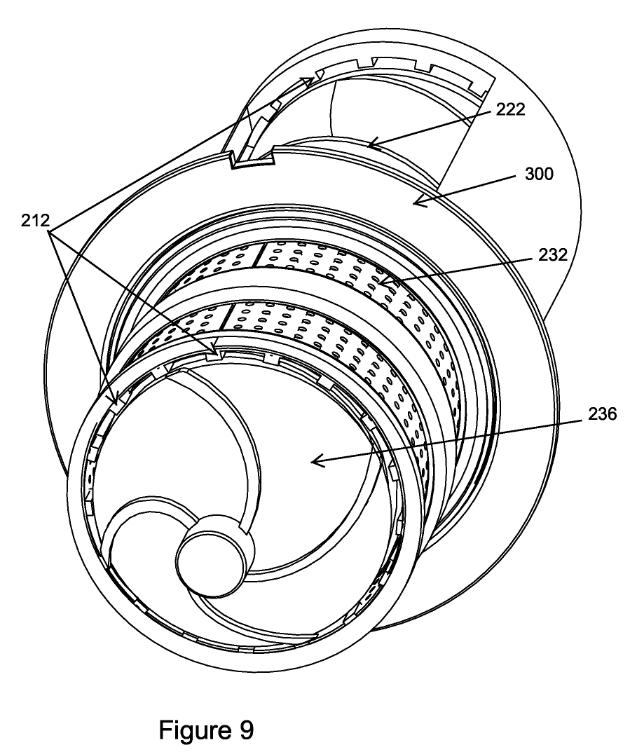

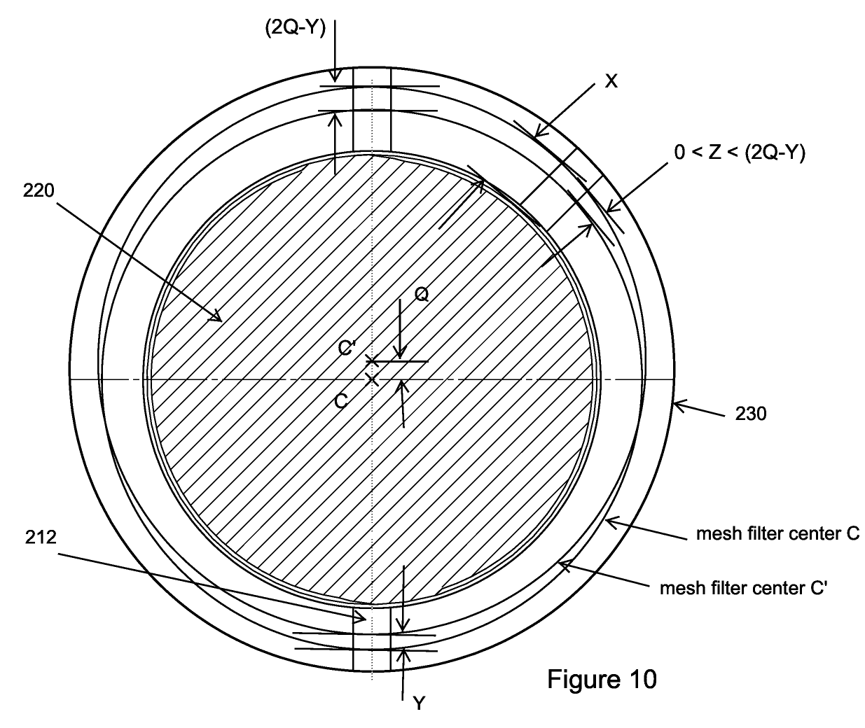

The juice extraction device 100 according to the current invention is capable of operating at a range of pressing pressures appropriate to the needs of the given food matters. To illustrate how the current invention works, a front isometric view of helical screw fitted inside a first exemplary mesh filter unit and process chamber unit is shown in FIG. 9. The corresponding cross section near the end of this cavity section, that is the end close to the helical screw conical front end 226, is shown in FIG. 10. Note that the following analysis equally applies to cross section at any point of the cavity enclosed by the contour mesh filter 232 and the helical screw 220. The distance between the cavity section within the helical screw 220 and the contour mesh filter 232 represents the depth of pulp matters being pressed, and is thus inversely proportional to the pressing pressure acts on the pulp. As show in FIG. 10, X is the distance between the cavity section of the helical screw 220 and the contour mesh filter 232. In all of the slow juicers currently commercially available in the market, the mesh filter and the helical screw are concentrically aligned, and therefore, the same distance X or same operating pressing pressure acts on the pulp matters at any cross section. Note that the current invention provides variable depth X circumferentially and therefore could operate at different circumferential pressing pressure as described below.

To achieve good juice extraction efficiency applicable to a variety of food matters with a wide range of textures, in the first exemplary contour mesh filter 232 shown in FIG. 9, at a given cross section perpendicular to the axis of rotation of the helical screw 220, the distance X between the cavity section of helical screw 220 and the contour mesh filter 232 on each side varies, but not remaining identical when the helical screw 220 rotates. Variable distances lead to different pressing pressures on the pulp matters when the juice extraction device 100 runs at a given speed. In this particular example, the contour mesh filter 232 of the juice extraction device 100 of the present invention is displaced from the axis along which the helical screw 220 is driven to rotate in order to provide a range of pressing pressures, and thus being more versatile and applicable to a range of fruits and vegetables with different textures and hardness. Preferably, the distance between the contour mesh filter 232 and the helical screw 220 on the side where the juice outlet 242 is placed is shortened due to the displacement of the contour mesh filter 232. In other words, the contour mesh filter 232 is displaced upwards relative to the helical screw 220 of the juice extraction device 100.

As shown in FIG. 9, the inner surface of the contour mesh filter 232 is relatively displaced from the axis along which the helical screw 220 is driven to rotate. In other words, the distance X between the cavity section of the helical screw 220 and the contour mesh filter 232 varies. More specifically, the distance X between the cavity section of the helical screw 220 and the contour mesh filter 232 gradually increases from one side to its opposite side.

Variation of the distance X between the cavity section of the helical screw 220 and the contour mesh filter 232 corresponds to different circumferential pressing pressure of the food matters as they are being pushed out from the contour mesh filter 232 to the dehydrated waste collector 402 through the waste outlet 234 on the contour mesh filter 232. The side with a smaller pulp thickness or distance X experiences higher pressing pressure than the side where protrusion 212 with thicker pulp thickness or distance X. This particular embodiment operates over a range of pressing pressures to satisfy the needs of a range of fruits and vegetables with different texture and hardness as oppose to conventional slow juicers where there is no circumferential variation due to its concentric structure with respect to the driving axis of rotation. In other words, the juice extraction device 100 with the contour mesh filter 232 shown in FIG. 9 is versatile and would be applicable to a wide range of food and vegetables with various textures and hardness.

In the preferred embodiments, the contour mesh filter 232 is preferably displaced relative to the side where the juice outlet 242 is placed, which means that once the juice is separated from the pulp matters by the contour mesh filter 232, the juice can have a shorter exit path and higher pressing pressure through the juice outlet 242 than from the opposing side.

FIG. 10 also shows the cross section of the circular contour mesh filter 232 with center C being concentrically aligned with the axis of rotation of the helical screw 220. For ease of discussion, only three protrusions 212, namely the top, bottom and an arbitrary one between these two are shown. In this embodiment, if the circular contour mesh filter 232 is relatively displaced or offset by a distance Q from the center of rotation axis C to C′ of the helical screw 220 as shown, the distance between the cavity section of the helical screw 220 and the circular contour mesh filter 232 will be reduced to (X−Y) at the bottom, while the distance between the cavity section of the helical screw 220 and the circular contour mesh filter 232 will be increased to X+(2Q−Y) at the top, whereas anywhere in between these two positions the distance between the cavity section of the helical screw 220 and the circular contour mesh filter 232 will be changed to X−Y+Z where 0<Z<(2Q−Y). In brief, the pressing pressure shifts from a circumferentially uniform value that inversely proportional to a pulp thickness of distance X to over a range of pressures which has the higher pressure that inversely proportional to a distance (X−Y) at the bottom, a lower pressure that inversely proportional to a distance X+(2Q−Y) at the top and different in-between pressures that inversely proportional to a distance X−Y+Z, where 0<Z<(2Q−Y) anywhere between the top and the bottom as shown in FIG. 10.

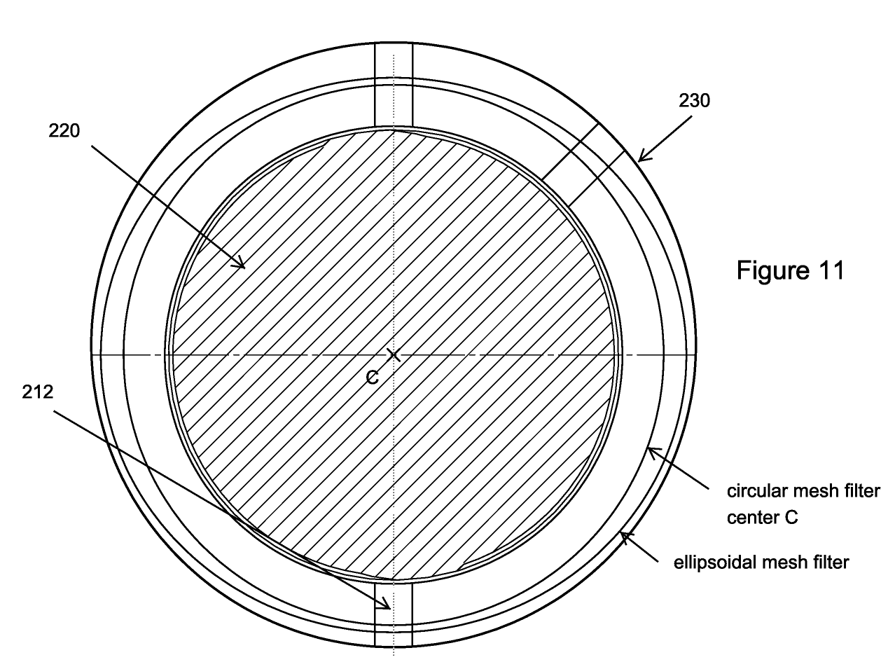

In a second exemplary contour mesh filter 232 shown in FIG. 11, the contour mesh filter now has a cross-sectional shape of an ellipse. Apparently, this ellipsoidal contour mesh filter 232 has variable distances between the cavity section of the helical screw along different points on the circumference of the contour mesh filter 232.

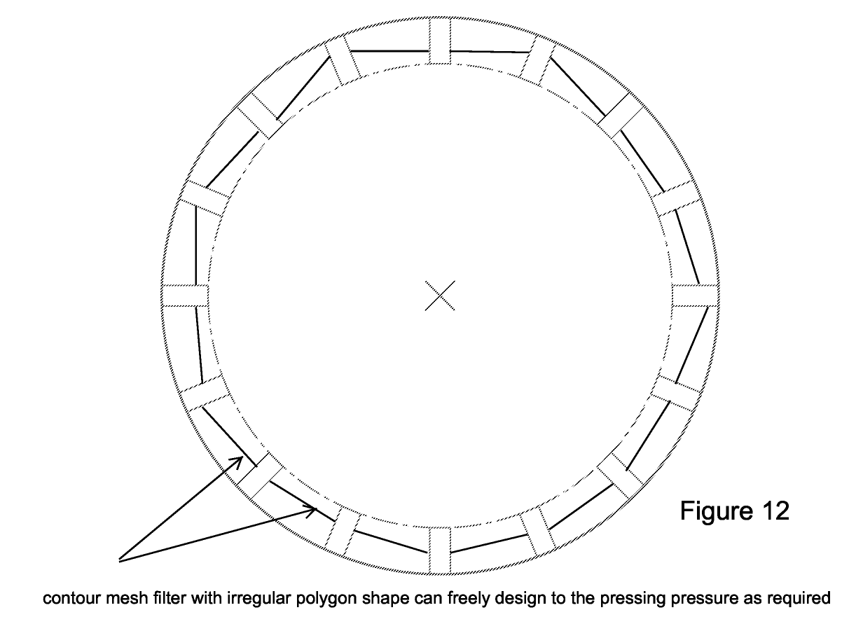

The above two contour mesh filter 232 shown in FIGS. 10 and 11 are tubular, and ellipsoidal with circular and elliptical cross sectional area, respectively. However, the contour mesh filter 232 of the present invention is not limited thereto, as long as the distance X between the cavity section of the helical screw 220 and the contour mesh filter 232 varies, thereby providing a range of pressing pressures. For example, in a third exemplary contour mesh filter 232 shown in FIG. 12, the circular contour mesh filter 232 is now replaced by an irregular polygon where any two adjacent protrusions are linked by a straight rather than an arc mesh filter, any point or otherwise any section of the contour mesh filter 232 can be designed and operated at a pre-determined thickness that inversely proportional to the desired pressing pressure. Therefore, the contour mesh filter 232 of the present invention is not of a particular shape. The mesh filter can be anything using an irregular polygon to replace the general standard cylindrical mesh filter.

Generally, food is preferred to be cut into small pieces before dropping into the assembled process chamber unit 210 and then the mesh filter unit 230 through the feed chute 104, as pushing and pressing whole food by the helical screw 220 would result in relatively low juice extraction efficiency. Also crushing and pressing a whole food requires considerable input power and a sizable work chamber to accommodate the process which makes it desirable to smaller portions rather than a whole food feed. The juice extraction efficiency and juice quality are affected by packing of the cut food in the assembled process chamber unit 210 and the mesh filter unit 230. Improved packing efficiency within the cavity of the process chamber can lead to improved juice extraction efficiency and juice quality. This issue may be solved by cutting the food before putting such into the juice extraction device 100 of this invention. However, this may be inconvenient if it is desired to put whole food into the juice extraction device 100. To deal with whole food and provide a better packing efficiency, the juice extraction mechanism 200 of the present invention may further include a cutter drum unit 300 with at least one cutting element 302 for cutting food from the feed chute 104. The cutter drum unit 300 encompasses at least part of the process chamber unit 210, and is also capable of being rotated by the driving mechanism 400 connected thereto. In other words, the drive mechanism 500 can drive at least one of the helical screw 220 and the cutter drum unit 300 if desired. The food from the feed chute 104 can then be cut into different sizes and/or shapes by different cutting elements of the rotating cutter drum unit 300, and the cut food can then enter the process chamber unit 210 with improved packing efficiency via the receiving opening of the process chamber unit 210. Details of the cutter drum unit 300 will be described below.

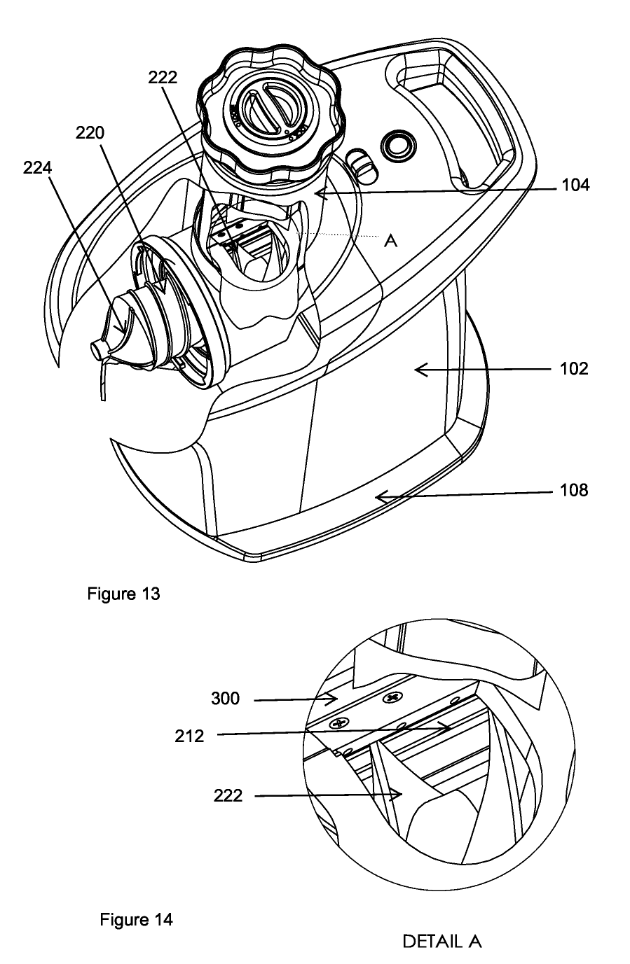

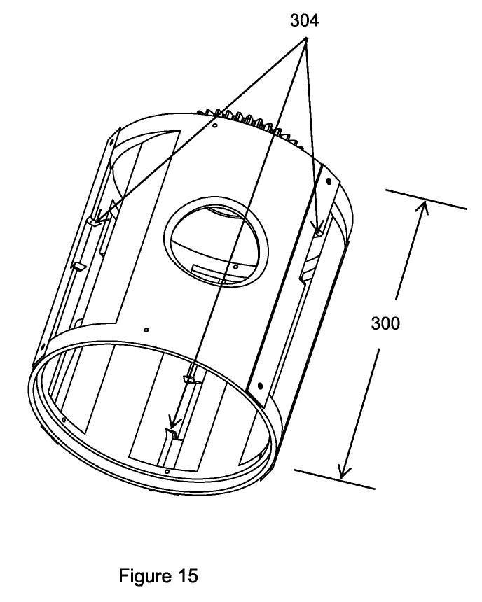

The cavity between the cutter drum unit 300 and the helical screw 220 is shown in FIG. 13, and an enlarged view (detail A) is shown in FIG. 14 for clarity. As described above, the food cut by the cutter drum unit 300 is fed into the process chamber unit 210 to be cut, pushed and pressed by the helical screw 220. Packing efficiency inside the assemble process chamber unit 210 and the mesh filter unit 230, especially inside the mesh filter unit 230 affects extraction efficiency of a juicer. Specifically, improved packing efficiency can result in reduction of void volume, which means less air (that is, less oxidation), and higher pressing pressure, and thus improving juice quality and extraction efficiency. Packing efficiency inside the assemble process chamber unit 210 and mesh filter unit 230 can be improved by accepting food that has been cut into different sizes and/or shapes. In the present invention, cutter drum unit 300 with various cutting elements 302 is used to achieve improved packing efficiency.

Specifically, three different exemplary cutter drum units 300 are shown in FIGS. 15 to 17. As shown in FIG. 15, the cutter drum unit 300 includes a plurality of strip cutting elements 304, and the circular opening on the cutter drum unit is an opening to allow the veggies fed. The plurality of strip cutting elements 304 can have the same size, or preferably has different sizes. In this embodiment, when the cutter drum unit 300 is driven to rotate, food from the feed chute 104 is cut into strips with different sizes. Because the cutting element 302 is provided with a plurality of strip cutting elements 304, which can cut food into strips, packing efficiency of the food inside the mesh filter unit 230 can be improved.

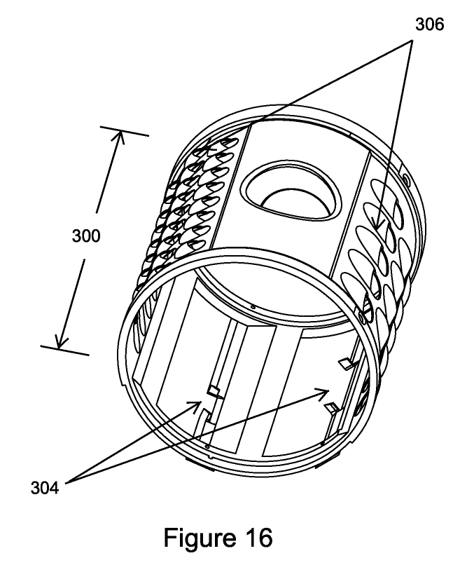

As shown in FIG. 16, the cutter drum unit 300 has a plurality of strip cutting elements 304 and a plurality of slice cutting elements 306. The plurality of strip cutting elements 304 can have the same size or preferably have different sizes. The same is applicable to the plurality of slice cutting elements 306. In this embodiment, when the cutter drum unit 300 is driven to rotate, food from the feed chute 104 is cut into strips and slices with different sizes. Appropriate different shapes and sizes can enhance the packing efficiency in the mesh filter unit 230.

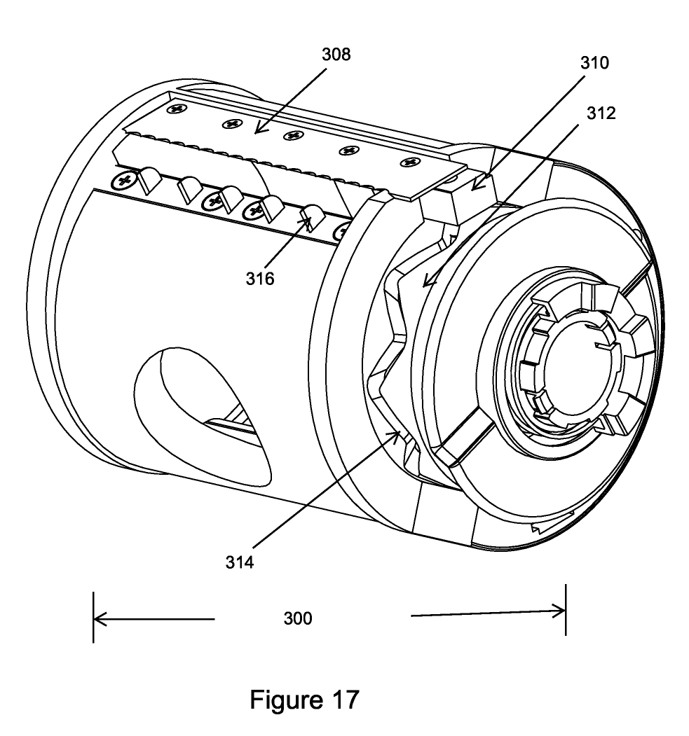

In another exemplary cutter drum unit 300 shown in FIG. 17, the cutter drum unit 300 has a reciprocating blade 308 connected to a moving block 310. The moving block 310 is movable along a zig-zag profile rail 314 through a slider accommodated in the zig-zag profile rail 314, for example, a protrusion of the moving block 310, a bolt fixed to the moving block 310, or the like. The zig-zag profile rail 314 is formed on a ring with zig-zag contour profile 312 which is fixed co-axially with the cutter drum unit 300, and cannot be rotated. When the cutter drum unit 300 is driven to rotate, the moving block 310 is rotated synchronously with the cutter drum unit 300 having the blade 308, while the ring with zig-zag contour profile 312 with the rail 314 is kept stationary and not movable, so that the movable block 310 moves along the zig-zag profile rail 314, and thus the blade 308 moves in a back and forth manner. Such back and forth movement of the reciprocating blade 308 cut the food. The path of zig-zag profile rail 314 is not limited to the inflected line shown in FIG. 17, it can be any line, such as repeated and continuous curve line, as long as it can cause the reciprocating blade 308 move in a back and forth fashion. Further, how the moving block 310 moves along the zig-zag profile rail 314 is not important in this invention, as long as it can move along the zig-zag profile rail 314 when the cutter drum unit 300 is driven to rotate. In addition, instead of rotating the cutter drum unit 300, the ring with zig-zag contour profile can be driven to rotate, while the cutter drum unit cannot be rotated, causing the reciprocating blade 308 to move in a back and forth manner.

For better cutting effect, the reciprocating blade 308 has curved teeth. To further strengthen the cutting effect, a plurality of vertical blades 316 whose edges are perpendicular to the plane of the reciprocating blade 308 are provided on the cutter drum unit 300. During operation, upon contacting with the food, the vertical blades 316 cut the food first, and then the reciprocating blade 308 further cut the food, or vice versa. Due to cutting in two directions perpendicular to each other, food is cut into small blocks whose size depends on the separation distances between two adjacent vertical blades 316, the height of these vertical blades 316 and the distances between the vertical blades 316 and the reciprocating blade 308.

In comparison to cutting food with unified shape and size, the food cut by the cutter drum unit 300 can be packed more closely in the assembled process chamber unit 210 and mesh filter unit 230, and thus void volume is reduced. For uncut food, uncut food gives maximum packing efficiency, however uncut whole food generally requires both impractically large driving power and out of proportion size-up mechanical parts to accommodate the uncut food fed into the cavity of the process chamber of the slow juicer. To improve packing efficiency, the cutter drum unit 300 is not limited to above examples shown in FIGS. 15 to 17, it may include any cutting element 302 described above, such as strip cutting element 304, slice cutting element 306 or any combination thereof. Further, each cutting element 302 may include reciprocating blade 308 and/or cutter drum unit 300. The shapes and sizes of the cutter drum unit 300 can be chosen according to its desired practical application, as long as it facilitates improving packing efficiency. For example, the cutter drum unit 300 can have only strip cutting elements 304 of different sizes if desired, or any combination of cutting elements with shapes including at least one of strip and slice shapes. The intention of having a variety of cutter elements to achieve different shapes and/or sizes cut is to provide better packing efficiency.

There is an additional benefit from cutting the food matters into smaller pieces that are closely packed inside the process chamber unit 210. Most commercial slow juicers crush the food matters by the helical blade before entering into the filter section and at the same time being pressed inside the filter section. This current invention, however, in a clever way converts most of the crushing power consumption into more productive juice pressing extraction process. This invention first process the food matters using sharp cutting edges which is more power efficient in breaking down the food matters than pure crushing by the helical blades. This extra power saving in the input driving power will then contribute to the pressing process whereby enhance the overall juice extraction performance.

The juice extraction device 100 includes the cutter drum unit 300 which provides a better packing that smaller portions of the food matters are fed into the pressing chamber, which makes it possible to re-format the juice extraction device 100 from a horizontal plain looking style to a more fashioned vertical driving look by including a bevel gear system that provide a 90 degree switch in the drive mechanism 500.

Each of the components of the juice extraction device 100 described above, such as the contour mesh filter 232 whose inner surface has different distance X from the helical screw 220 and the cutter drum unit 300, can be individually and separately installed to the juice extraction device 100. That is, the juice extraction device 100 can include at least one of the contour mesh filter 232 whose inner surface has different distance X from the helical screw 220, the cutter drum unit 300, and their combinations. Further, the drive mechanism 500 can selectively drive the helical screw 220 and/or the cutter drum unit 300. How the drive mechanism 500 drives the helical screw 220 and/or the cutter drum unit 300 is not important in this invention, as long as the drive mechanism 500 can drive the other necessary components, particularly the helical screw 220 to rotate. For ease of implementation, the helical screw 220 and the cutter drum unit 300 are coaxially connected to the drive mechanism 500 in the present invention, although they can be non-coaxially connected if desired. Furthermore, the cross-section of the cutter drum unit 300 and the contour mesh filter 230 may be of any general cylindrical shape including circular, hexagonal, octagonal, or the like.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. A juice extraction device for extracting juice from food, including:
a housing having at least one food inlet;
a process chamber unit having at least one opening matching the at least one food inlet to receive the food;
a helical screw capable of being rotated by a driver connected thereto along an axis;
a mesh filter unit for separating the juice from the food, said mesh filter unit connected to the process chamber unit to encompass the helical screw, wherein the mesh filter unit has a cross-sectional shape perpendicular to the axis;
at least one outlet where the juice exits, the at least one outlet is at a side of the mesh filter unit,
characterized in that the distance between the helical screw and the mesh filter unit varies.

2. The juice extraction device according to claim 1, wherein the mesh filter unit includes at least a contour mesh filter.

3. The juice extraction device according to claim 2, wherein the cross-sectional shape of the contour mesh filter is circular.

4. The juice extraction device according to claim 2, wherein the cross-sectional shape of the contour mesh filter is semi-ellipsoidal or ellipsoidal.

5. The juice extraction device according to claim 2, wherein the cross-sectional shape of the contour mesh filter is irregular polygon.

6. The juice extraction device according to claim 1, further including a cutter drum unit having at least one cutting element for cutting the food from the at least one food inlet, the cutter drum unit is capable of being rotated by the driver connected thereto along the axis and encompasses at least part of the process chamber unit.

7. The juice extraction device according to claim 6, wherein the cutter drum unit has a plurality of cutting elements, and the plurality of cutting elements has at least two different sizes and at least two different shapes.

8. The juice extraction device according to claim 7, wherein the shapes of the plurality of cutting elements includes at least strip and slice shapes.

9. The juice extraction device according to claim 7, wherein the cutting element includes a reciprocating blade, when the cutting element is driven to rotate, the reciprocating blade is moved in a reciprocating manner.

10. The juice extraction device according to claim 7, further comprising a plurality of vertical blades, the edges of the vertical blades are perpendicular to those of the reciprocating blade.

11. The juice extraction device according to claim 1, wherein the driver is a manual driver.

12. The juice extraction device according to claim 1, wherein the driver is a motor.

13. The juice extraction device according to claim 1, further including a cap with at least one waste outlet on a tip side thereof, the cap matches a tip end of the helical screw and is connected to the housing.
